(19) United States
(12) Patent Application Publication
(10) Pub. No.: US 2012/0062616 A1
(43) Pub. Date: Mar. 15, 2012

(54) REFLECTIVE COLOR DISPLAY ELEMENT AND COLOR DISPLAY APPARATUS

(75) Inventor: Masaki Nose, Kawasaki (JP)

(73) Assignee: FUJITSU LIMITED, Kawasaki (JP)

(21) Appl. No.: 13/227,714

(22) Filed: Sep. 8, 2011

(30) Foreign Application Priority Data
Sep. 15, 2010 (JP) 2010-206896

(51) Int. Cl. G09G 5/10

(52) U.S. Cl. 345/690; 345/88

(57) ABSTRACT

A reflective color display element includes a plurality of pixels arranged in a matrix. Each of the plurality of pixels includes a first hue element, a second hue element, and a third hue element that control a light reflection state and that exhibit three different hues. Reflection spectra of the first hue element, the second hue element, and the third hue element partially overlap.

### CROSS-REFERENCE TO RELATED APPLICATIONS

This application is based upon and claims the benefit of priority of the prior Japanese Patent Application No. 2010-206896, filed on Sep. 15, 2010 the entire contents of which are incorporated herein by reference.

### FIELD

The present invention relates to a reflective color display element and a color display apparatus.

### BACKGROUND

Today, companies and universities are actively developing electronic paper. In the electronic paper market, various mobile devices, such as electronic books, sub-displays of mobile terminals, and display units of integrated circuit (IC) cards are expected.

In one method for realizing electronic paper, a cholesteric liquid crystal is used. A cholesteric liquid crystal has excellent characteristics such as semi-permanent display maintaining properties (memory properties), vivid color display, high contrast, and high resolution.

A cholesteric liquid crystal used in electronic paper or the like has a wide color reproduction range compared to other methods such as electrophoresis, but the color reproducibility thereof is insufficient compared to backlight liquid crystal display (LCD). In other words, there is a range in which excellent color display can be realized, but there is also a range in which satisfactory color display cannot be realized. In particular, display of flesh colors and greens is unsatisfactory.

Related art is disclosed in Japanese Laid-open Patent Publication No. 11-064895, International Publication No. WO2007/004280, and Japanese Laid-open Patent Publication No. 2008-292632.

### SUMMARY

According to one aspect of the invention, a reflective color display element includes a plurality of pixels arranged in a matrix. Each of the plurality of pixels includes a first hue element, a second hue element, and a third hue element that control a light reflection state and that exhibit three different hues. Reflection spectra of the first hue element, the second hue element, and the third hue element partially overlap.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams illustrating states of a cholesteric liquid crystal.

FIGS. 2A to 2F are diagrams illustrating examples of voltage response characteristics in response to pulses having various periods when the initial state of a cholesteric liquid crystal display element is a planar state.

FIG. 3 is a sectional view of a reflective color display element having a three-layer structure.

FIG. 4 is a diagram illustrating a reflection spectrum of each layer of the reflective color display element in the planar state.

FIG. 5 is a diagram illustrating the relationships between a wavelength spectrum and the names of colors.

FIG. 6 is a diagram illustrating an effect produced by reducing the wavelengths of the reflected colors of blue and green layers to be shorter than those in the sRGB and by reducing the half width of the reflection spectrum of the green layer to be smaller than those of red and blue layers using MacAdam's discrimination thresholds (ellipses) in an embodiment.

FIG. 7 is a diagram illustrating reflection spectra of a representative example of a reflective color display element adopting a cholesteric liquid crystal.

FIG. 8 is a diagram illustrating a color volume of the representative example of a reflective color display element adopting a cholesteric liquid crystal in the CIELAB color space.

FIG. 9 is a diagram illustrating reflection spectra of a reflective color display element according to the embodiment adopting a cholesteric liquid crystal.

FIG. 10 is a diagram illustrating a color volume of the reflective color display element according to the embodiment adopting a cholesteric liquid crystal in the CIELAB color space.

FIG. 11 is a diagram illustrating the optimum values of the main wavelength and the half width of each layer at which the color volume is maximized when the parameters of the display element, such as the order in which the layers are stacked, use of the cut-off filter, and the environmental conditions (that is, whether the observation is performed outdoors or indoors) are changed.

FIG. 12 is a diagram illustrating a comparison between the color gamuts of the representative example of the display element in the related art and the display element according to the embodiment on the xy chromaticity diagram.

FIG. 13 is a diagram illustrating the configuration of a simple matrix type reflective color display element according to the embodiment adopting a cholesteric liquid crystal.

FIG. 14 is a diagram illustrating the basis configuration of a single panel.

FIG. 15 is a diagram illustrating the relationship between the amount of a chiral dopants added to a liquid crystal composition, which is applied to a liquid crystal layer, and the center wavelength of reflection of the liquid crystal layer.

FIG. 16 is a diagram illustrating the relationship between the anisotropy (Δn) in the index of refraction and the half width of the reflection spectrum.

FIG. 17A is a plan view of the configuration of a display element having a structure in which RGB pixels are arranged side-by-side, and FIG. 17B is a sectional view of the configuration of the display element.

FIG. 18 is a diagram illustrating the schematic configuration of a display apparatus in which the reflective color display element according to the embodiment is used.

### DETAILED DESCRIPTION OF THE EMBODIMENTS

One of the causes of unsatisfactory color display is the characteristics of a reflection spectrum. In the reflection spectrum of a cholesteric liquid crystal element in the related art, the center wavelength of reflection of a green (G) layer is arranged close to 555 nm (yellow green), at which the luminosity exhibits a peak value, compared to a standard RGB color model, in order to increase the brightness as much as possible. In addition, the center wavelengths of reflection of a blue (B) layer and a red (R) layer are arranged close to the wavelength of the green layer in order to maintain the gray balance. Because of such characteristics, whereas the cholesteric liquid crystal can obtain a certain degree of brightness, the three colors are arranged close to green, which undesirably reduces the color reproduction range.

In addition, a single material (a nematic liquid crystal or a chiral dopants) is normally used for liquid crystal compositions. Therefore, there is a relationship represented by an expression “Wavelength λ=n·p” (n denotes an average index of refraction and p denotes a helical pitch), and, with respect to the half width (Δλ), a relational expression “Δλ=Δn·Δp” is established. Therefore, a general relationship is “Red>Green>Blue”. It is to be noted the half width Δλ is a wavelength width at which the reflectivity is half the peak value. However, when the half width has such a relationship, the chroma of blue tends to be too high and that of red tends to be too low, thereby making it difficult to maintain an appropriate RGB color balance.

Next, the operation principle of a display element adopting a cholesteric liquid crystal will be described.

A cholesteric liquid crystal may be referred to as a chiral nematic liquid crystal and is a liquid crystal in which molecules of a nematic liquid crystal form a helical cholesteric phase when a relatively large amount (several tens of percent) of a chiral additive (also referred to as a chiral dopants) has been added to the nematic liquid crystal. A display element adopting a cholesteric liquid crystal performs control of display using the orientation state of liquid crystal molecules therein.

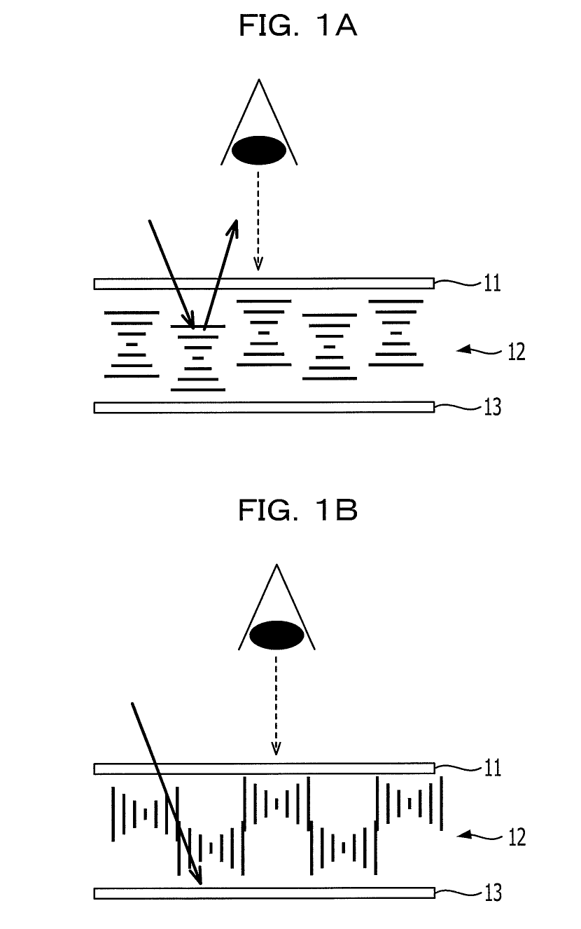

FIGS. 1A and 1B are diagrams illustrating states of a cholesteric liquid crystal. As illustrated in FIGS. 1A and 1B, a display element 10 adopting a cholesteric liquid crystal has an upper substrate 11, a cholesteric liquid crystal layer 12, and a lower substrate 13. A cholesteric liquid crystal may be in a planar state in which, as illustrated in FIG. 1A, incident light is reflected, or, in a focal conic state in which, as illustrated in FIG. 1B, incident light passes. These states are stably maintained even when no electric field is present.

In the planar state, the cholesteric liquid crystal reflects light having a wavelength corresponding to the helical pitch of liquid crystal molecules thereof. A wavelength λ at which the degree of reflection is largest is represented by the following expression using the average index of refraction n and the helical pitch p:

λ=n·p

On the other hand, a reflection bandwidth Δλ becomes larger as the anisotropy Δn in the index of refraction of the liquid crystal becomes larger.

In the planar state, since incident light is reflected, the display element 10 is in a “bright” state, that is, it displays white. On the other hand, in the focal conic state, by providing a light absorption layer under the lower substrate 13, light that has passed through the cholesteric liquid crystal layer 12 is absorbed, and therefore the display element 10 is in a “dark” state, that is, it displays black.

Next, the driving principle of the display element adopting a cholesteric crystal will be described.

If a strong electric field is applied to a liquid crystal, the helical structure of liquid crystal molecules is completely broken and the homeotropic state is established in which all the molecules follow the direction of the electric field. Next, if the electric field is suddenly reduced to zero from the homeotropic state, the helical axis of the liquid crystal is oriented perpendicular to the electrodes and a planar state is established, in which light corresponding to the helical pitch is selectively reflected. On the other hand, if the electric field has been removed, after an electric field that is weak enough to maintain the helical structure of the liquid crystal molecules has been generated, or, if a strong electric field has been applied and then gradually removed, the helical axis of the liquid crystal becomes parallel to the electrodes and the focal conic state is established in which incident light passes through the liquid crystal. In addition, if an electric field having moderate strength has been applied and then suddenly removed, the planar state and the focal conic state coexist, thereby enabling display of middle tones. Information is displayed by utilizing these phenomena.

A lot of methods have been disclosed as driving methods to be used to display an image on the display element adopting a cholesteric liquid crystal, and these methods can be roughly divided into “conventional driving methods” and “dynamic driving methods”. In a dynamic driving method, a transient planar state is used in addition to the homeotropic state, the planar state, and the focal conic state, which have been described above. In a dynamic driving method, the content of display can be updated at relatively high speed, but there has been a problem in that precise tone control is difficult. In contrast, in a conventional driving method, it is possible to realize a high-definition display by performing precise tone control, but there has been a problem in that it takes a long period of time to update the content of display. Here, a case in which a display element adopting a cholesteric liquid crystal is driven by a conventional driving method will be described as an example.

In a conventional driving method, high voltage is applied to all pixels to establish the homeotropic state, and then a reset operation is performed in which an electric field is removed and all the pixels enter the planar state or the focal conic state. After that, using a simple matrix driving method, a write operation is performed in which write pulses having relatively low voltages and small pulse widths are applied in order to change the states of individual pixels from the planar state or the focal conic state. Below, a case in which all the pixels enter the planar state through the reset operation and then, by the write operation, the planar state is maintained or changed to the focal conic state, or, a state in which the planar state and the focal conic state coexist, will be described as an example.

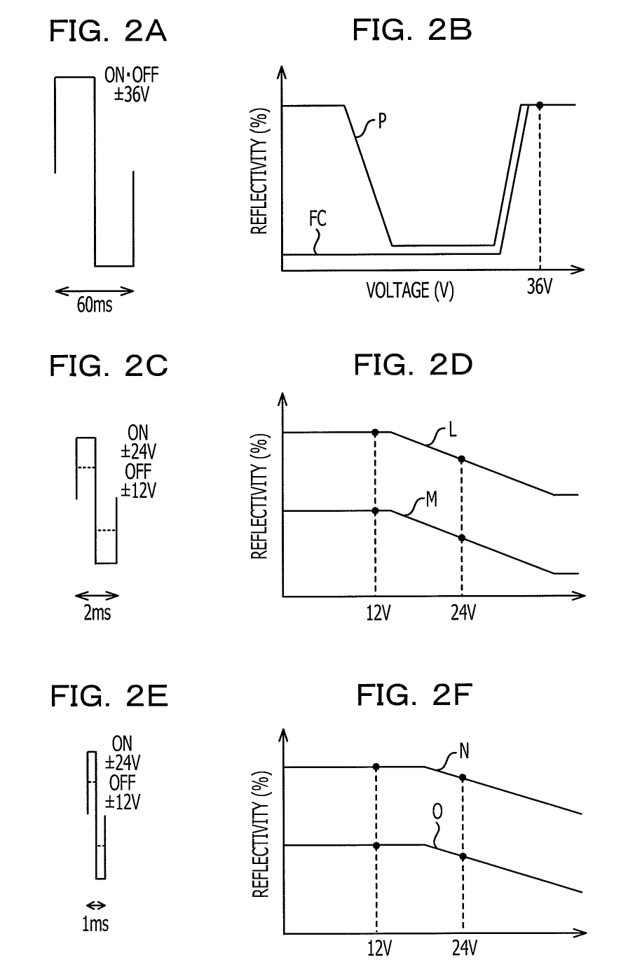

FIG. 2A is a diagram illustrating an example of a voltage waveform applied to a liquid crystal cell (pixel) in a conventional driving method, and FIG. 2B is a diagram illustrating an example of the response characteristic of the reflectivity when the voltage waveform illustrated in FIG. 1 is applied in the conventional driving method. FIG. 2A illustrates a reset voltage waveform (pulses) to be applied in the reset operation. FIG. 2B illustrates a response to the application of the reset pulses. FIG. 2C illustrates an example of a write voltage waveform (pulses) to be applied in the write operation. FIG. 2D illustrates a response to the application of the write pulses illustrated in FIG. 2C when the initial state is the planar state. FIG. 2E illustrates write pulses having a width smaller than that of the write pulses illustrated in FIG. 2C. FIG. 2F illustrates a response to the application of the write pulses illustrated in FIG. 2E when the initial state is the planar state. In other words, FIGS. 2D and 2F illustrate changes in an inclination on the left side part of a line P illustrated in FIG. 2B.

As in the case of a common liquid crystal, the driving waveform of a cholesteric liquid crystal needs to be an alternating current waveform in order to suppress deterioration (polarization) of a liquid crystal material. Therefore, a liquid crystal driver IC (a cholesteric liquid crystal IC or a super-twisted nematic (STN) liquid crystal IC is generally used) has a function of reversing the polarity of an electric field applied to a liquid crystal cell. As a high-voltage power supply for driving the liquid crystal, a single power supply having positive several ten volts may be used.

First will be described changes in the state that is caused when the pulse voltage is gradually increased from 0 V in a case in which are applied the pulses illustrated in FIG. 2A having a wide pulse width, namely 60 ms, which is the sum of the pulse widths of a positive pulse and a negative pulse. If the initial state is the planar state, the state changes along the line P illustrated in FIG. 2B. When the pulse voltage exceeds a certain voltage, the focal conic state is gradually established and the reflectivity sharply drops. After reaching the minimum value, the reflectivity hardly changes unless the pulse voltage exceeds a certain voltage. If the pulse voltage exceeds the certain voltage, the planar state is gradually established and the reflectivity sharply rises. After reaching the maximum value, the reflectivity does not change even if the pulse voltage is increased. Such voltage-reflectivity characteristics are generally called “VR characteristics”. If the initial state is the focal conic state, the state changes along a line FC illustrated in FIG. 2B. The reflectivity does not change unless the pulse voltage exceeds a certain voltage. If the pulse voltage exceeds the certain voltage, the planar state is gradually established and the reflectivity sharply rises. After reaching the maximum value, the reflectivity does not change even if the pulse voltage is increased. Regardless of the initial state being the planar state or the focal conic state, a planar state in which the reflectivity has the maximum value is invariably established if a voltage equal to or more than a certain voltage is applied. In FIG. 2B, if pulses having a pulse width of 60 ms and a voltage of ±36 V are applied, the planar state is invariably established. Therefore, these pulses can be used as the reset pulses.

If pulses having a pulse width smaller than that described above are applied, the response changes. For example, if pulses having a pulse width of 2 ms and a pulse voltage of ±24 V or ±12 V illustrated in FIG. 2C are applied, the state changes along a line L illustrated in FIG. 2D when the initial state is the planar state. In FIG. 2D, the reflectivity does not change in the case of the pulses having a pulse voltage of ±12 V, and the planar state is maintained. In the case of the pulses having a pulse voltage of ±24 V, the reflectivity slightly decreases, thereby obtaining middle tones. In addition, if the initial state is a state in which the planar state and the focal conic state coexist and the reflectivity has a moderate value, the state changes along a line M illustrated in FIG. 2D. In this case, too, the reflectivity does not change in the case of the pulses having a pulse voltage of ±12 V. In the case of the pulses having a pulse voltage of ±24 V, the reflectivity slightly decreases.

Furthermore, if pulses having a pulse width of 1 ms and a pulse voltage of ±24 V or ±12 V illustrated in FIG. 2E are applied, the state changes along a line N illustrated in FIG. 2F when the initial state is the planar state. In FIG. 2F, the reflectivity does not change in the case of the pulses having a pulse voltage of ±12 V, and the planar state is maintained. In the case of the pulses having a pulse voltage of ±24 V, the reflectivity slightly decreases and middle tones are obtained; however, the amount of decrease in the reflectivity is smaller than in the case of the pulses having a pulse width of 2 ms. That is, tones are darker in the case of the pulses having a pulse width of 2 ms than in the case of the pulses having a pulse width of 1 ms. If the initial state is a state in which the planar state and the focal conic state coexist and the reflectivity has a moderate value, the state changes along a line O illustrated in FIG. 2F. In this case, too, the reflectivity does not change in the case of the pulses having a pulse voltage of ±12 V. In the case of the pulses having a pulse voltage of ±24 V, the reflectivity slightly decreases.

From the above description, it can be seen that if the initial state is the planar state, the reflectivity decreases when pulses having a relatively small voltage are applied, and the amount of decrease in the reflectivity varies depending on the pulse voltage and the pulse width. More specifically, the higher the pulse voltage, and the larger the pulse width, the larger the amount of decrease in the reflectivity. In addition, as can be seen from changes illustrated by the lines M and O in FIGS. 2D and 2F, respectively, even if pulses are applied separately, the same changes are caused and the amount of decrease in the reflectivity depends on the sum of the pulse widths, that is, the cumulative time of application of the pulses.

An example in which the initial state is the planar state, and the inclination on the left side part of the line P illustrated in FIG. 2B is utilized, has been described. However, the same holds true for a case in which the initial state is the focal conic state and an inclination on the right side part of the line FC illustrated in FIG. 2B is utilized.

Furthermore, various driving methods have also been proposed as the conventional driving methods; however, detailed description thereof is omitted herein.

As described above, there are various driving methods that have respective advantages and disadvantages. Therefore, an appropriate driving method needs to be selected in accordance with the usage. A display element adopting a cholesteric liquid according to an embodiment that will be described hereinafter may use any of the above-described driving methods.

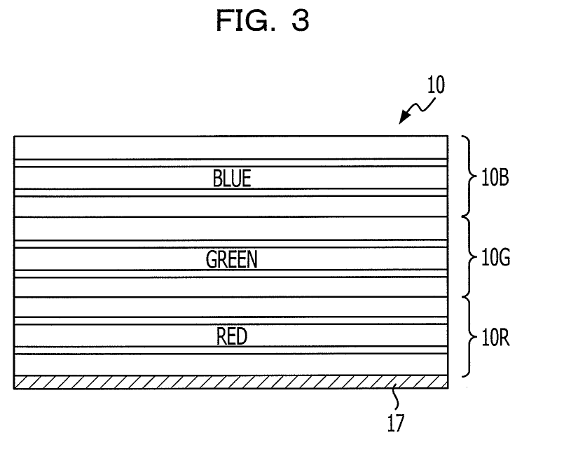

FIG. 3 is a schematic sectional view of a reflective color display element in which three cholesteric liquid crystal layers are stacked.

As described in FIG. 3, in a display element 10, a blue panel 10B, a green panel 10G, and a red panel 1OR are stacked in this order from a display (observed) surface. A light absorption layer 17 is provided under the red panel 10R. The blue panel 10B, the green panel 10G, and the red panel 10R have the same configuration, but the liquid crystal material and the chiral dopants thereof are selected, and the percentage of the chiral dopants is determined, such that the center wavelength of reflection of the blue panel 10B is a wavelength of blue, that of the green panel 10G is a wavelength of green, and that of the red panel 10R is a wavelength of red. The stacked three panels each include pixels formed therein, and pixels of the reflective color display element include the pixels of the stacked three panels. Since the pixels of each panel exhibit a certain reflected color, the pixels of each panel may be referred to as a hue element and the hue elements of the three panels may be referred to as a first hue element, a second hue element, and a third hue element, respectively, herein. The center wavelength of the reflection spectrum of each hue element herein is supposed to be the shortest in the first hue element and the longest in the third hue element. Therefore, in the example illustrated in FIG. 3, the first hue element corresponds to the pixels of the blue panel 10B, the second hue element corresponds to the pixels of the green panel 10G, and the third hue element corresponds to the pixels of the red panel 10R.

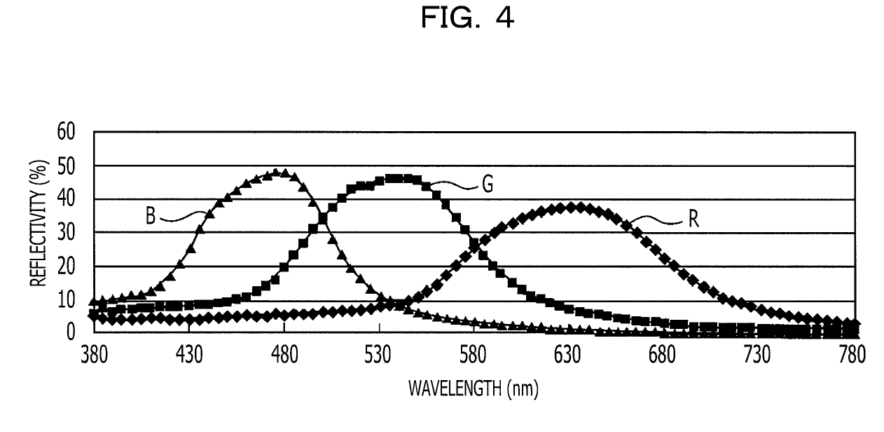

FIG. 4 is a diagram illustrating a representative example of the spectral reflection characteristic of each layer used in the reflective color display element illustrated in FIG. 3 in the planar state. In FIG. 4, reflection spectra B, G, and R are obtained from the blue layer 10B, the green layer 10G, and the red layer 10R, respectively. In FIG. 4, the spectral reflection characteristic of each layer approximately has the normal distribution. The center wavelength of reflection of the blue layer 10B is about 480 mm, that of the green layer 10G is about 550 mm, and that of the red layer 10R is about 630 mm.

As described above, the reflection spectra of the representative example of a cholesteric liquid element in the related art, the center wavelength of reflection of the green (G) layer 10G is arranged close to 555 nm (yellow green), at which the luminosity exhibits a peak value, compared to the standard RGB color model, in order to increase the brightness as much as possible. In addition, the center wavelengths of reflection of the blue layer 10B and the red layer lOR are arranged close to the center wavelength of reflection of the green layer 10G, in order to maintain the gray balance. Therefore, whereas a certain degree of brightness can be obtained, the three colors are arranged close to green, which undesirably reduces the color reproduction range.

In addition, a single material (a nematic liquid crystal or a chiral dopants) is normally used for liquid crystal compositions. Therefore, there is a relationship represented by an expression λ=n·p (n denotes an average index of refraction and p denotes a helical pitch), and, with respect to the half width (Δλ), a relational expression Δλ=Δn·Δp is established. Therefore, a general relationship is Red>Green>Blue. However, when the half width has such a relationship, the chroma of blue tends to be too high and that of red tends to be too low, thereby making it difficult to maintain an appropriate RGB color balance.

In addition to the above example, a technique has been proposed in which the chroma of red is improved by reducing the half width of the spectral reflection characteristic of a red layer among the three layers of R, G, and B. Such a characteristic is realized by reducing the anisotropy (Δn) in the index of refraction of a nematic liquid crystal, which serves as the host of a cholesteric liquid crystal, to a minimum in the red layer among the three layers of R, G, and B or by reducing the helical twisting power of a chiral dopants to be added to a minimum in the red layer.

However, it has been found that, even if the half width Δλ of the spectral reflection characteristic of the red layer is reduced to be smaller than those of the green layer and the blue layer, it is difficult to sufficiently improve the color reproduction range.

In addition, a technique has been proposed (not in a reflective color display element adopting a cholesteric liquid crystal but in a transmission liquid crystal display element adopting backlight) in which the spectral characteristics of backlight (that is, for example, characteristics according to the luminous characteristics of a light-emitting diode) is used as the characteristics of color filters. However, these characteristics cannot be applied to a reflective color display element adopting a cholesteric liquid crystal.

As described above, in a reflective color liquid crystal display element adopting a cholesteric liquid crystal layer having a unique reflection characteristic approximate to the normal distribution, realization of the maximum color reproduction range has not been considered. According to a reflective color display element adopting a cholesteric liquid crystal layer that will be described hereinafter, the color reproduction range is increased and the qualities of color display such as the color saturation in color display are improved.

Before the embodiment is described, the relationships between the names of colors to be used herein and wavelength spectra will be described.

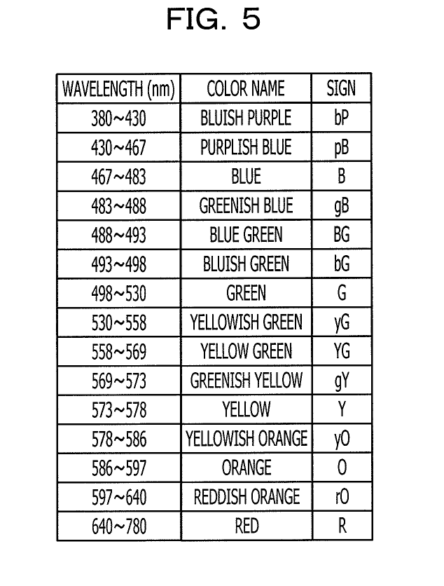

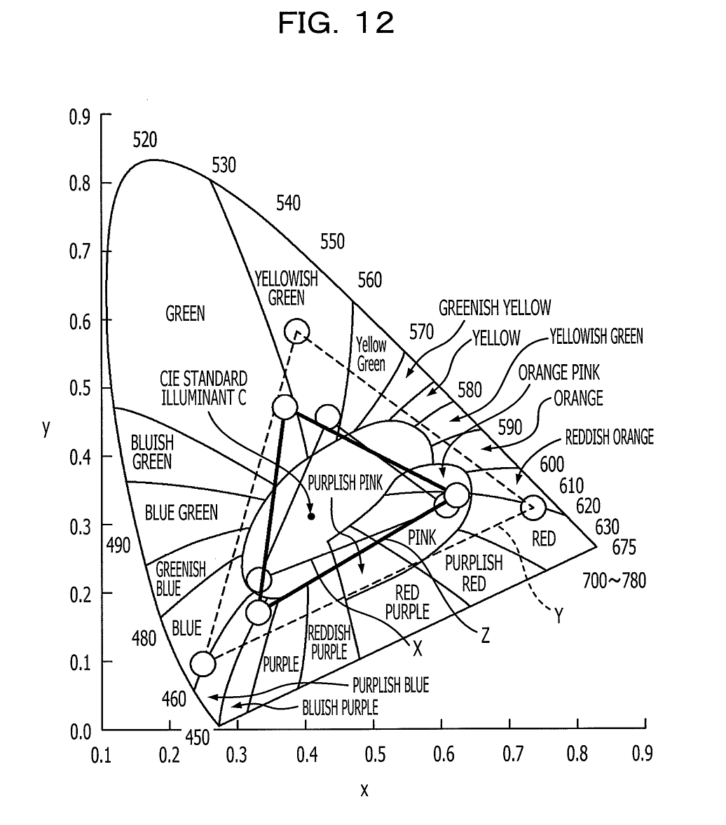

FIG. 5 is a diagram illustrating the relationships between wavelength spectra and the names of colors. In FIG. 5, the names of colors and signs used to indicate the colors are illustrated. The name of a color having a wavelength spectrum ranging from 380 to 430 nm is “bluish purple”. The name of a color having a wavelength spectrum ranging from 430 to 467 nm is “purplish blue”. The name of a color having a wavelength spectrum ranging from 467 to 483 nm is “blue”. The name of a color having a wavelength spectrum ranging from 483 to 488 nm is “greenish blue”. The name of a color having a wavelength spectrum ranging from 488 to 493 nm is “blue green”. The name of a color having a wavelength spectrum ranging from 493 to 498 nm is “bluish green”. The name of a color having a wavelength spectrum ranging from 498 to 530 nm is “green”. The name of a color having a wavelength spectrum ranging from 530 to 558 nm is “yellowish green”. The name of a color having a wavelength spectrum ranging from 558 to 569 nm is “yellow green”. The name of a color having a wavelength spectrum ranging from 569 to 573 nm is “greenish yellow”. The name of a color having a wavelength spectrum ranging from 573 to 578 nm is “yellow”. The name of a color having a wavelength spectrum ranging from 578 to 586 nm is “yellowish orange”. The name of a color having a wavelength spectrum ranging from 586 to 597 nm is “orange”. The name of a color having a wavelength spectrum ranging from 597 to 640 nm is “reddish orange”. The name of a color having a wavelength spectrum ranging from 640 to 780 nm is “red”. In addition, as illustrated in FIG. 12, which will be referred to later, the names of colors such as “pink” and “orange pink” are also used.

Because a “color volume” can be considered to be most appropriate as an index of the color reproduction range, the magnitude of the color reproduction range is represented by the color volume. In the following description, the standard RGB (sRGB), which is standardized by the International Electrotechnical Commission (IEC) and the like as the standard specification of displays, will be used as a standard.

First, the center wavelength of reflection (hereinafter referred to as the main wavelength) of each liquid crystal layer will be described. The main wavelength relates to the hue of a reflected color of each liquid crystal layer.

In a common reflective color display element adopting a cholesteric liquid crystal, the reflected color of a blue layer is substantially the same as the B of the sRGB. The reflected color of a green layer is the same as the G of the sRGB or is a color shifted to the long wavelength side, and the reflected color of a red layer is substantially the same as the R of the sRGB. However, in the case of a cholesteric liquid crystal, which has a wide spectrum, it is preferable that the wavelengths of the reflected colors of the blue and green layers are shorter than those according to the sRGB in view of a balance between the brightness and the chroma. It is to be noted that the reflected color of the red layer may be substantially the same as the R of the sRGB. By setting the reflected color of each liquid crystal layer, it is possible to reproduce a region close to memory colors such as a region ranging from dark blue to deep green, thereby maximizing the entire color reproduction range.

Next, the half width (Δλ) of the reflection spectrum of each liquid crystal layer will be described.

In the sRGB, each spectrum is ideally a narrow spectrum and therefore the spectra of adjacent colors do not overlap. In the case of a reflective color display element, it is preferable that the reflection spectra of the blue and green layers do not overlap and the reflection spectra of the green and red layers do not overlap. However, because a cholesteric liquid crystal layer exhibits reflected colors caused by interference reflection and the widths of the reflection spectra of the cholesteric liquid crystal layer are so large that the reflection spectra of adjacent colors partially overlap, the conditions of the cholesteric liquid crystal layer are different from those of the sRGB.

As described above, since a single material (a nematic liquid crystal or a chiral dopants) is used for cholesteric liquid crystal compositions, a general relationship of the half width Δλ of each layer is Red>Green>Blue on the basis of the relationship represented by an expression λ=n·p. In other words, the half width of the blue layer is the smallest. In addition, as described above, a technique has been proposed in which the half width of the red layer is reduced to be smaller than those of the green and blue layers.

On the other hand, in the embodiment, the half width of the reflection spectrum of the green layer is reduced to be smaller than those of the red and blue layers. The half width Δλ of each layer is supposed to be Red>Blue≧Green. Thus, whereas the half width of the green layer is between those of the blue layer and the red layer in the related art, the half width of the green layer in the embodiment is the smallest among those of the layers of the three colors. Therefore, it is possible to reproduce deeper green.

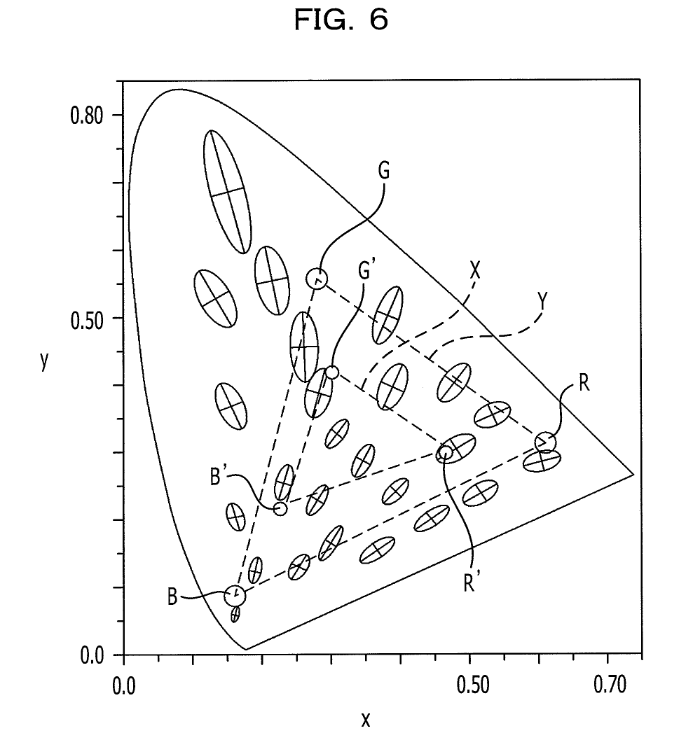

FIG. 6 is a diagram illustrating an effect produced by reducing the wavelengths of the reflected colors of the blue and green layers to be shorter than those in the sRGB and by reducing the half width of the reflection spectrum of the green layer to be smaller than those of the red and blue layers using MacAdam's discrimination thresholds (ellipses). MacAdam's discrimination thresholds (ellipses) are minimum differences (discrimination thresholds) for discriminating between the chromaticity of two color stimuli having the same brightness. FIG. 6 illustrates the discrimination thresholds (ellipses) on the xy chromaticity diagram.

In FIG. 6, a triangle X represents a color reproduction range at a time when the reflection spectra of the three layers have the characteristics illustrated in FIG. 4, and a triangle Y represents a color reproduction range according to the sRGB. In FIG. 6, reducing the wavelengths corresponds to rotating vertices B′, G′, and R′ counterclockwise relative to white (substantially the central position of the triangle X) and, on the other hand, increasing the wavelengths corresponds to rotating the vertices B′, G′, and R′ clockwise.

If the wavelength of the vertex B′ is reduced, the difference between colors that can be discriminated increases, and if the bandwidth is reduced, that is, if the half width is reduced, the color purity of colors to be displayed can be improved. If the wavelength and the bandwidth of the vertex G′ are reduced, the difference between colors that can be discriminated increases and the color purity of colors to be displayed can be improved. If the wavelength of the vertex R′ is reduced, the vertex R′ moves away from a vertex R of the sRGB and becomes orange, and if the wavelength of the vertex R′ is increased to be longer than that of the vertex R of the sRGB, the vertex R′ becomes brown. Therefore, the vertex R′ is preferably the same as the vertex R of the sRGB.

More specifically, when the cholesteric liquid crystal has a wide reflection spectrum, if the blue (B) layer has a main wavelength equal to that according to the sRGB, impure color components (for example, cyan) are undesirably included. Therefore, in FIG. 6, the main wavelength is shifted from the vertex B′ to a vertex B, that is, to the short wavelength side, in order to reduce the amount of the included cyan component. At this time, when the wavelength is shifted to the short wavelength side, the chroma of blue (B) is improved while the brightness of blue (B) decreases. In order to correct the decrease in the brightness, in the embodiment, the half width is determined to be larger than that of green (G), which will be described later, and smaller than that of red (R). In doing so, it is possible to minimize the decrease in the brightness and reproduce the hues in the dark blue region. This relative relationship makes it possible to maximize the color volume. In other words, in terms of maximizing the color reproduction range, it is preferable that the main wavelength of blue (B) is shorter than that according to the sRGB and the half width of blue (B) is larger than that of green (G) and smaller than that of red (R). More specifically, the reflection spectrum of the blue (B) layer preferably has a main wavelength in a range from 430 to 460 nm and a half width in a range from 75 to 115 nm.

When the cholesteric liquid crystal has a wide reflection spectrum, if the green (G) layer has a main wavelength of approximately 550 nm, a lot of yellow (Y) components are included and the chroma of green is the smallest, which makes it difficult to reproduce important colors such as deep green. In order to increase the chroma of green (G), first, the main wavelength is reduced to reduce the yellow (Y) components. In this reduction of the wavelength, as can be seen from the ellipses illustrated in FIG. 6, since the vertex G′ is shifted to the short axis side of the ellipses, it is possible to visually improve the tone dramatically, thereby significantly improving the chroma.

The half width of the reflection spectrum of the green (G) layer is, unlike the blue (B) layer, preferably smaller than in the related art. By reducing the half width of the reflection spectrum of the green (G) layer to some degree at the expense of the brightness, the chroma is preferentially improved, which contributes to maximizing the color volume. That is, it is preferable to reduce the half width in order to further increase the chroma.

In short, in terms of maximizing the color reproduction range, the main wavelength of the reflection spectrum of the green (G) layer is preferably shorter than that according to the sRGB, and the half width of the reflection spectrum of the green (G) layer is preferably smaller than those of the blue (B) and red (R) layers. More specifically, the reflection spectrum of the green (G) layer preferably has a main wavelength in a range from 510 to 540 nm and a half width in a range from 75 to 115 nm.

The main wavelength of the reflection spectrum of the red (R) layer is preferably the same as that according to the sRGB. If the main wavelength is shorter, impure components such as colors ranging from orange to yellow increase, and if the main wavelength is longer, the brightness decreases and the color becomes close to brown. Therefore, the main wavelength is preferably the same as that according to the sRGB.

The half width of the reflection spectrum of the red (R) layer is, as in a general example, preferably the largest among R, G, and B. If the half width is reduced by reducing the anisotropy Δn in the index of refraction of the red (R) liquid crystal layer, the maximum point of the color volume is deviated from, thereby undesirably reducing the color volume.

In short, in terms of maximizing the color reproduction range of the display element, the main wavelength of the reflection spectrum of the red (R) layer is preferably approximately the same as that according to the sRGB and the half width of the reflection spectrum of the red (R) layer is preferably larger than those of the blue (B) and green (G) layers. More specifically, the reflection spectrum of the red (R) layer preferably has a main wavelength in a range from 600 to 630 nm and a half width in a range from 95 to 135 nm.

It is to be noted that, in the relative relationships between the half widths of the reflection spectra of the three layers of R, G, and B, the larger half widths are preferably 1.5 to 1.9 times larger than the smallest half width.

The requirements of the main wavelengths and the half widths are as described above. If these requirements are converted into the anisotropy (Δn) in the index of refraction of the liquid crystal material, it is preferable that the anisotropy Δn in the index of refraction of the blue (B) layer is the largest among the three layers and the anisotropies Δn in the indices of refraction of the green (G) and red (R) layers are substantially the same. In other words, it is preferable to have the following relationship:

Δn of blue (B) layer>Δn of green (G) layer≈Δn of red (R) layer.

It is to be noted that a general example of the related art has the following relationship:

Δn of blue (B) layer=Δn of green (G) layer=Δn of red (R) layer.

More specifically, it is preferable that the anisotropies Δn in the indices of refraction of the three layers are within the range of 0.18 to 0.25, that the anisotropies Δn in the indices of refraction of the green (G) and red (R) layers are within the range of ±10% of each other, and that the anisotropy Δn in the index of refraction of the blue (B) layer is within the range of 110 to 130% of that of the green (G) layer or the red (R) layer.

Furthermore, it is preferable that the peak value of the reflection spectrum of each layer is not significantly different among the three layers of R, G, and B and that the larger peak values among the three layers of R, G, and B are 1.0 to 1.5 times larger than the smallest peak value. This is important in order to maintain the color reproduction range.

Furthermore, when the blue (B) layer, the green (G) layer, and the red (R) layer are stacked in this order from the surface to be observed (display surface), if a blue cut-off filter is provided between the blue (B) and green (G) layers and a green cut-off filter is provided between the green (G) and red (R) layers, the chroma can be further improved. The blue cut-off filter and the green cut-off filter are effective even if either the blue cut-off filter or the green cut-off filter is provided.

Now, the color gamuts of the representative example of a reflective color display element adopting a cholesteric liquid crystal in the related art and the reflective color display element according to the embodiment are compared using the color volumes. The comparison was conducted using reflective color display elements, each including the blue (B) layer, the green (G) layer, and the red (R) layer stacked in this order from the surface to be observed. In each reflective color display element, a green cut-off filter was provided between the green (G) and red (R) layers in order to emphasize the chroma of red. Measurement was conducted under an illuminance equivalent to outdoor illuminance.

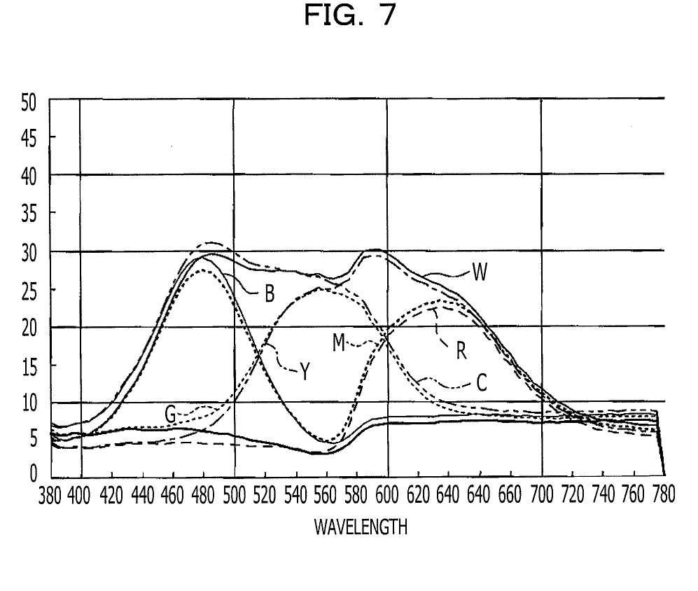

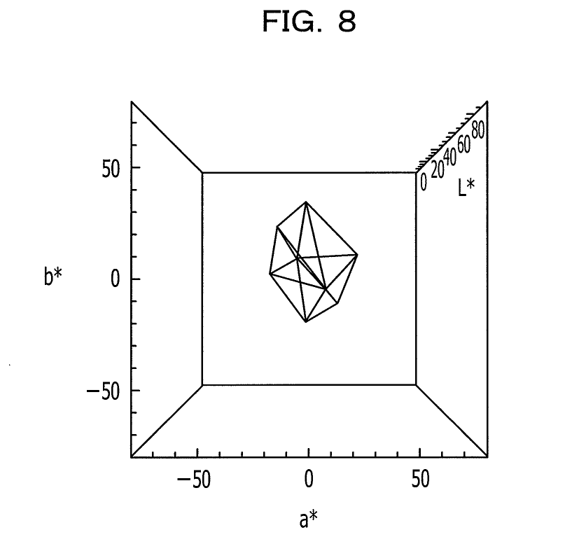

FIG. 7 is a diagram illustrating reflection spectra of the representative example of a reflective color display element adopting a cholesteric liquid crystal. FIG. 8 is a diagram illustrating the color volume of the representative example of a reflective color display element adopting a cholesteric liquid crystal in the CIELAB color space. A color volume represents a range in which colors can be reproduced for display.

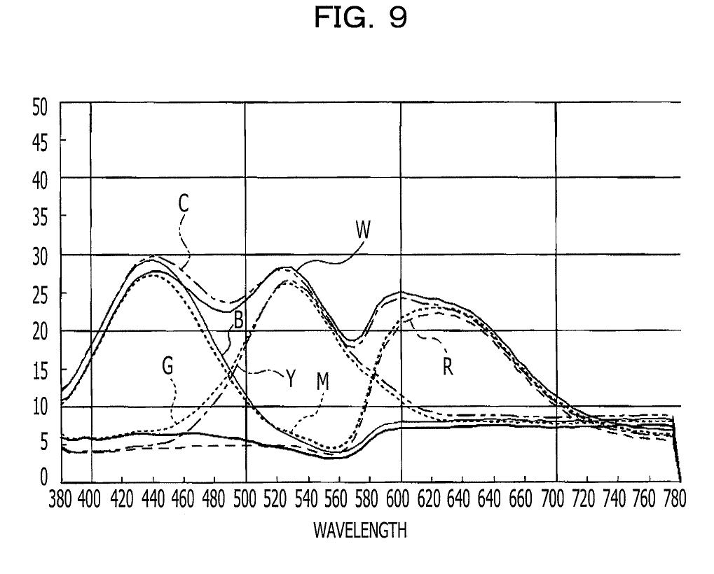

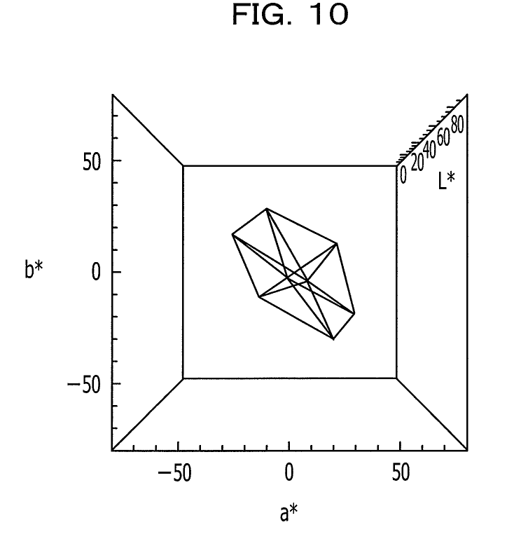

FIG. 9 is a diagram illustrating reflection spectra of the reflective color display element according to the embodiment adopting a cholesteric liquid crystal. FIG. 10 is a diagram illustrating the color volume of the reflective color display element according to the embodiment adopting a cholesteric liquid crystal in the CIELAB color space.

As illustrated in FIG. 8, in the configuration of the reflection spectra of the representative example of a reflective color display element in which the brightness is given top priority, the color volume is 20,116 (relative value). In addition, as illustrated in FIG. 7, in the color reproduction range of the representative example, the reproduction capabilities for colors ranging from dark blue to deep green, purple, and the like are low.

On the other hand, as illustrated in FIG. 10, in the configuration of the reflection spectra of the reflective color display element according to the embodiment, the color volume is 30,118 (relative value), which is approximately 1.5 times larger than in the case of the reflection spectra illustrated in FIG. 7. In addition, as illustrated in FIG. 9, in the color reproduction range of the reflective color display element according to the embodiment, the reproduction capabilities for colors ranging from dark blue to deep green, purple, and the like are improved, the number of colors that cover the Macbeth chart, which includes representative colors, is increased, and the chroma of colors ranging from red to magenta is increased.

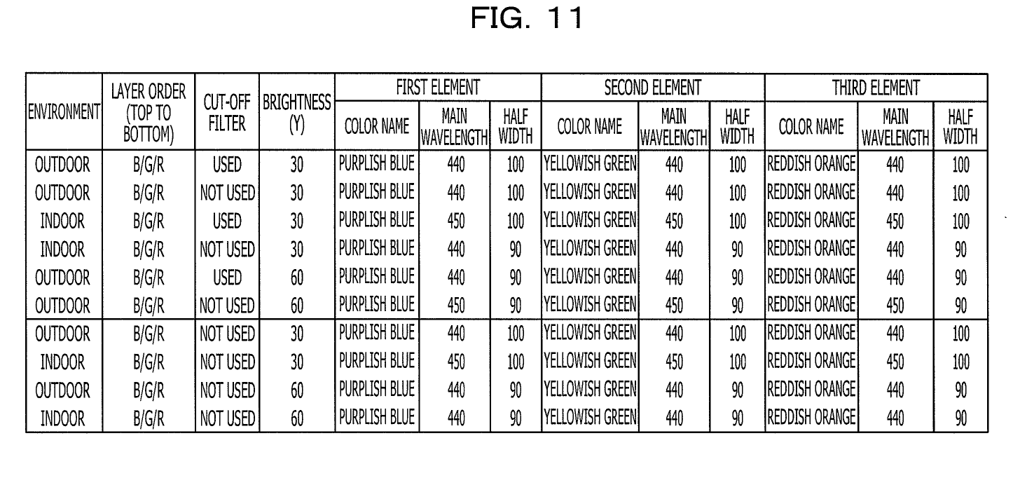

FIG. 11 illustrates the optimum values of the main wavelength and the half width of each layer at which the color volume is maximized when the parameters of the display element such as the order in which the layers are stacked, use of the cut-off filter, and the environmental conditions, that is, whether the observation is performed outdoors or indoors are changed. A brightness of 30 corresponds to a display element in the related art and a brightness of 60 corresponds to a newspaper. A first, a second, and a third elements correspond to the three layers arranged in the order from the shortest to longest main wavelength. More specifically, the first element corresponds to the blue (B) layer, the second element corresponds to the green (G) layer, and the third element corresponds to the red (R) layer.

Conditions under which the color volume is maximized do not depend on these parameters, and the main wavelength and the half width of each layer of the display element are steady because of the high robustness thereof. Thus, since the robustness of the main wavelength and the half width of each layer of the display element is high, these requirements are effective not only for the layered structure but also for a structure in which RGB pixels are arranged side-by-side.

FIG. 12 is a diagram illustrating a comparison between the color gamuts of the representative example of the display element in the related art and the display element according to the embodiment on the xy chromaticity diagram in the CIE XYZ color coordinate system. In FIG. 12, a triangle X represents the color reproduction range of the representative example of the display element in the related art, a triangle Y represents the sRGB, and a triangle Z represents the color reproduction range of the display element according to the embodiment. FIG. 12 also illustrates a range corresponding to the names of colors illustrated in FIG. 5.

The area of the triangle Z of the color reproduction range of the display element according to the embodiment is larger than that of the triangle X of the color reproduction range of the representative example of the display element in the related art on the xy chromaticity diagram, which means that the color reproduction range has been enlarged.

As can be seen from FIG. 12, it is preferable that the blue (B) layer is arranged in the color region of purplish blue, the green (G) layer is arranged in the color region of green or yellowish green, and the red (R) layer is arranged in the color region of orange pink or reddish orange.

The color characteristics of the three liquid crystal layers according to the embodiment have been described. Next, the reflective color display element according to the embodiment adopting a cholesteric liquid crystal that realizes the above-described color characteristics.

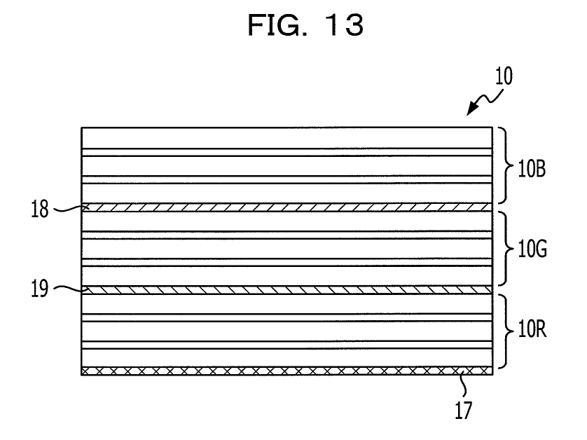

FIG. 13 is a diagram illustrating the configuration of a simple matrix type reflective color display element 10 according to the embodiment adopting a cholesteric liquid crystal. As illustrated in FIG. 13, in the display element 10, a blue (B) panel 10B, a green (G) panel 10G, and a red (R) panel 10R are stacked in this order from a surface to be seen. A light absorption layer 17 is provided under the red layer 10R. A blue cut-off filter layer 18 is formed between the blue panel 10B and the green panel 10G, and a green cut-off filter layer 19 is formed between the green panel 10G and the red panel 10R. The blue cut-off filter layer 19 absorbs blue, and the green cut-off filter layer 19 absorbs green.

The liquid crystal material and the chiral dopants are selected and the percentage of the chiral dopants is determined such that the center wavelength of reflection of the blue layer 10B is close to a wavelength of blue, that of the green layer 10G is close to a wavelength of green, and that of the red layer 10R is close to a wavelength of red. Common electrodes and segment electrodes of the blue panel 10B, the green panel 10G, and the red panel 10R are driven by a common driver and segment drivers, respectively.

The blue panel 10B, the green panel 10G, and the red panel lOR have the same configuration, except that the center wavelengths of reflection thereof are different. A representative example of the blue panel 10B, the green panel 10G, and the red panel 10R will be represented as a panel 10A, and the configuration of the panel 10A will be described.

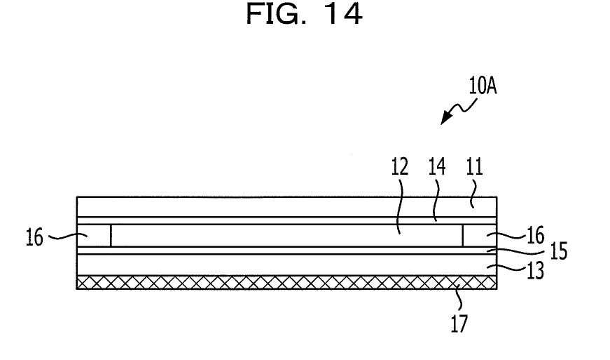

FIG. 14 is a diagram illustrating the basic configuration of the panel 10A.

As illustrated in FIG. 14, the display element 10A has an upper substrate 11, an upper electrode layer 14 provided on a surface of the upper substrate 11, a lower electrode layer 15 provided on a surface of a lower substrate 13, and sealant 16. The upper substrate 11 and the lower substrate 13 are arranged such that electrodes thereof face each other. A cholesteric liquid crystal material is applied between the upper substrate 11 and the lower substrate 13 and then the sealant 16 is applied. It is to be noted that spacer is disposed within a liquid crystal layer 12. A plurality of common electrodes are formed on either the upper electrode layer 14 or the lower electrode layer 15 and a plurality of segment electrodes are formed on the other, but the electrodes are not illustrated. The plurality of common electrodes and the plurality of segment electrodes are transparent strip electrodes that are parallel to one another and are disposed in such a way as to be perpendicular to each other when viewed from the surface to be observed (display surface). The common driver and the segment drivers apply voltage pulse signals to the plurality of common electrodes and the plurality of segment electrodes, thereby applying voltage to the liquid crystal layer 12. By applying voltage to the liquid crystal layer 12, the planar state or the focal conic state is established in liquid crystal molecules in the liquid crystal layer 12 and accordingly display is realized.

The upper substrate 11 and the lower substrate 13 have transparency, but the lower substrate 13, which is the lowest panel in the layered structure, may be opaque. Substrates having transparency include a glass substrate, a polyethylene terephthalate (PET) film substrate, and a polycarbonate (PC) film substrate.

The upper electrode and the lower electrode are typically transparent conductive films composed of indium tin oxide (ITO). Alternatively, for example, transparent conductive films composed of indium zinc oxide (IZO) or the like may be used.

Insulation films are formed on the electrodes. If the insulation films are thick, the drive voltage rises and therefore a general-purpose STN driver cannot be used. On the other hand, if there are no insulation films, leakage current is undesirably generated and the power consumption increases. The insulation films have a relative dielectric constant of about 5, which is much lower than that of a liquid crystal. Therefore, the thickness of the insulation films is preferably about 0.3 μm or less.

The spacer is inserted between the upper substrate 11 and the lower substrate 13 in order to maintain an even gap between the upper substrate 11 and the lower substrate 13. In general, sphere-shaped spacers composed of a resin or an inorganic oxide are evenly sprayed before the upper substrate 11 and the lower substrate 13 are attached to each other. Alternatively, fixing spacers coated with a thermoplastic resin may be provided. A cell gap formed by the spacer is preferably within the range from 3 to 6 μm. If the cell gap is smaller than this range, the reflectivity decreases to cause the display to be dark, and high threshold steepness cannot be expected. On the other hand, if the cell gap is larger than the range, high threshold steepness can be maintained, but the drive voltage rises and driving using general-purpose components becomes difficult.

A liquid crystal composition applied to the liquid crystal layer 12 is a cholesteric liquid crystal obtained by adding a chiral dopants to a nematic liquid crystal mixture at a ratio of 10 to 40 wt %. Here, the amount of the chiral dopants to be added is a percentage when the total amount of the nematic liquid crystal component and the chiral dopants is supposed to be 100 wt %. As the nematic crystal material, various materials that are already known may be used, but the appropriate range of the dielectric anisotropy (Ac) is 15 to 25. If the dielectric anisotropy is less than 15, the drive voltage is generally high and it is difficult to use general-purpose components in the drive circuit. On the other hand, if the dielectric anisotropy is more than 25, the range of applied voltage in which the planar state is changed to the focal conic state is small and therefore the threshold steepness is seen to decrease. Furthermore, the reliability of the liquid crystal material itself becomes doubtful.

The anisotropy (Δn) in the index of refraction is preferably within the range from about 0.18 to 0.25. If the anisotropy in the index of refraction is smaller than this range, the reflectivity in the planar state undesirably decreases. If the anisotropy in the index of refraction is larger than this range, the degree of scatter reflection in the focal conic state is undesirably large, as well as the viscosity being high and the response speed being low.

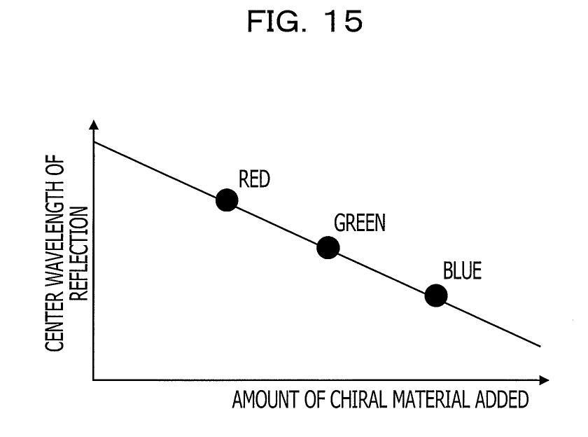

FIG. 15 is a diagram illustrating the relationship between the amount of a chiral dopants added to a liquid crystal composition, which is then applied to a liquid crystal layer, and the center wavelength of reflection of the liquid crystal layer. As illustrated in FIG. 15, the center wavelength of reflection linearly decreases as the amount of a chiral dopants added increases.

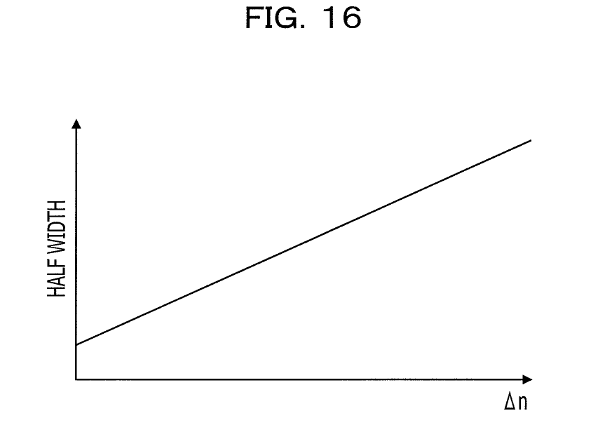

In addition, FIG. 16 is a diagram illustrating the relationship between the anisotropy Δn in the index of refraction and the half width of the reflection spectrum. As can be seen from FIG. 16, the half width linearly increases as the anisotropy Δn in the index of refraction increases. The anisotropy Δn in the index of refraction can be controlled by selecting the types of nematic liquid crystal mixture and chiral dopants and by determining the mixture ratio of the nematic liquid crystal mixture and the chiral dopants.

As described above, the main wavelength of the blue (B) layer 10B is preferably within the range from 430 to 460 nm and the half width of the blue (B) layer 10B is preferably within the range from 75 to 115 nm. The main wavelength of the green (G) layer 10G is preferably within the range from 510 to 540 nm and the half width of the green (G) layer 10G is preferably within the range from 75 to 115 nm. The main wavelength of the red (R) layer 10R is preferably within the range from 600 to 630 nm and the half width of the red (R) layer 10R is preferably within the range from 95 to 135 nm. Furthermore, it is preferable that the anisotropies Δn in the indices of refraction of the three layers are within the range of 0.18 to 0.25, that the anisotropies Δn in the indices of refraction of the green (G) layer 10G and the red (R) layer 10R are within the range of ±10% of each other, and that the anisotropy Δn in the index of refraction of the blue (B) layer 10B is within the range of 110 to 130% of that of the green (G) layer 10G or the red (R) layer 10R.

The above-described characteristics of each liquid crystal layer can be realized by appropriately selecting the types of nematic liquid crystal mixture and chiral dopants and the amount of the chiral dopants to be added (mixture ratio).

Although an example, in which a display element having a three-layer structure in which the blue panel 10B, the green panel 10G, and the red panel 10R are stacked, has been described in the above embodiment, since the robustness of the main wavelength and the half width of each layer of the display element is high as described above, the above embodiment may be applied to a structure in which RGB pixels are arranged side-by-side.

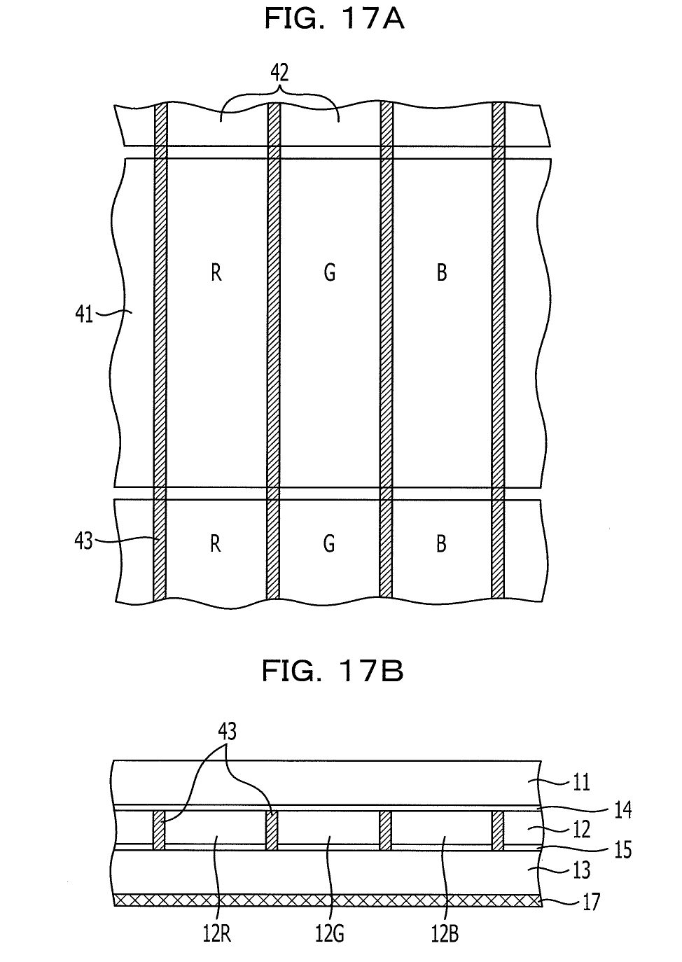

FIG. 17A is a plan view of the configuration of a display element having a structure in which RGB pixels are arranged side-by-side, and FIG. 17B is a sectional view of the configuration of the display element. The display element has division walls 43 provided between two substrates 11 and 13. The division walls 43 divide a space between the two substrates 11 and 13 into a plurality of strip regions. The plurality of strip regions are divided into three groups, namely blue liquid crystal layers 12B, green liquid crystal layer 12G, and red liquid crystal layers 12R, which are arranged alternately. In the blue liquid crystal layers 12B, a cholesteric liquid crystal that exhibits a reflection spectrum having a main wavelength in a range from 430 to 460 nm and a half width in a range from 75 to 115 nm is applied. In the green liquid crystal layers 12G, a cholesteric liquid crystal that exhibits a reflection spectrum having a main wavelength in a range from 510 to 540 nm and a half width in a range from 75 to 115 nm is applied. In the red liquid crystal layers 12R, a cholesteric liquid crystal that exhibits a reflection spectrum having a main wavelength in a range from 600 to 630 nm and a half width in a range from 95 to 135 nm is applied.

Common electrodes 41 extend in the lateral direction. Segment electrodes 42 extend in the longitudinal direction and are provided in such a way as to overlap the strip regions. Pixels are formed in intersecting portions between the common electrodes 41 and the segment electrodes 42. In the display element illustrated in FIGS. 17A and 17B, three pixels adjacent to one another (that is, a blue liquid crystal layer 12B, a green liquid crystal layer 12G, and a red liquid crystal layer 12R) form a single display pixel. The single display pixel can realize color display by itself, but the brightness thereof is about one-third that of the three-layer structure.

It is to be noted that a reflective color display apparatus having a two-layer structure in which two panels that each include two strip region groups are stacked and the resultant four strip region groups include at least three types of liquid crystal layers, namely R, G, and B, may be realized. The three types of liquid crystal layers in such a reflective color display apparatus having a two-layer structure may have the above-described spectral reflection characteristics.

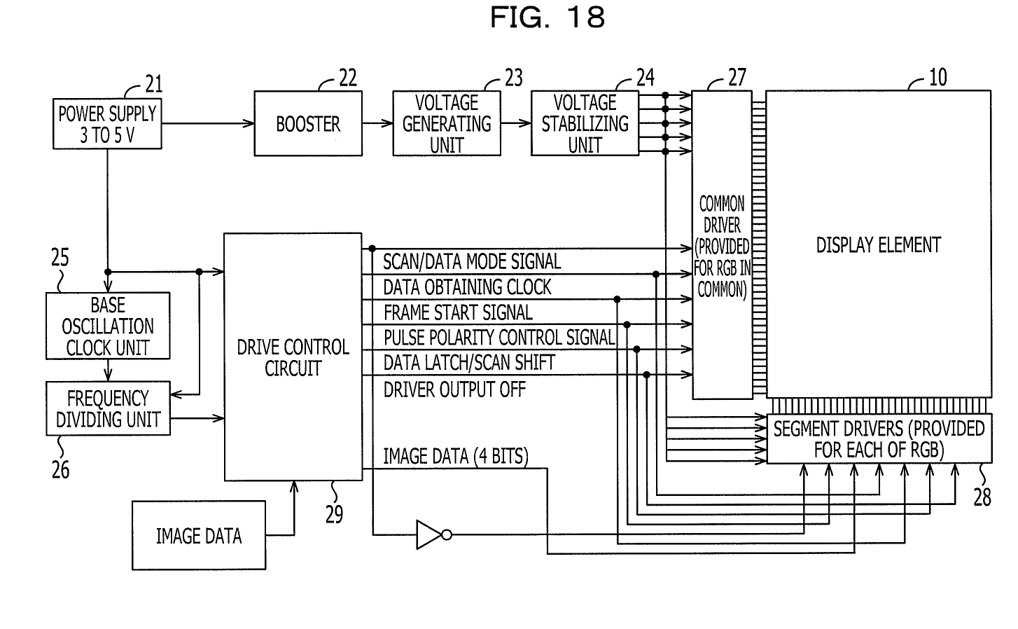

FIG. 18 is a block diagram illustrating the schematic configuration of a display apparatus in which the above-described simple matrix type reflective color display element 10 according to the embodiment adopting a cholesteric liquid crystal is used.

The display apparatus has the display element 10, a power supply 21, a booster 22, a voltage generating unit 23, a voltage stabilizing unit 24, a base oscillation clock unit 25, a frequency dividing unit 26, a common driver 27, segment drivers 28, and a drive control circuit 29.

The display element 10 is the simple matrix type reflective color liquid crystal display element according to the embodiment adopting a cholesteric liquid crystal.

The number of pixels of the display element 10 is the Extended Graphics Array (XGA; 1024 horizontal pixels and 768 vertical pixels). The method for driving the display element 10 is the above-described conventional driving method. However, a dynamic driving method may be used instead.

The power supply 21 is formed by a portion that receives power supplied from outside, a battery or the like, and outputs a direct voltage of 3 to 5 V. The booster 22 has a DC/DC converter or the like and increases the direct voltage of 3 to 5 V to about 40 V, which is required as the drive voltage of a liquid crystal. This boost regulator preferably has high conversion efficiency in relation to the load characteristics of the display element 10, that is, in relation to charge and discharge of a capacitor at a constant period.

The voltage generating unit 23 generates a voltage of 36 V from the increased voltage during the reset operation and generates an analog voltage (about 0, 10, 17, or 24 V) during the write operation. A high-voltage analog switch is used for switching between the reset voltage and the tone writing voltage. A switching circuit including a simple transistor may be adopted instead.

The voltage stabilizing unit 24 has a voltage follower circuit of an operator amplifier and stabilizes the voltage during charge and discharge. The operator amplifier to be used is preferably one that is not easily affected by capacitive load.

The base oscillation clock unit 25 generates base clock pulses that serve as the base of the operation. The frequency dividing unit 26 divides the base clock pulses in order to generate various clock pulses that are necessary for operations, which will be described later.

An output terminal of the common driver 27 is connected to 768 common electrodes of the display element 10. Output terminals of the segment drivers 28 are connected to 1024 segment electrodes of the display element 10. Since the common electrodes are selected by the three panels of R, G, and B in common, the common driver 27 is used by the three panels of R, G, and B in common. On the other hand, because image data applied to the segment electrodes of the three panels of R, G, and B is different between the three panels, the segment drivers 28 are separately provided for the three panels of R, G, and B. The common driver 27 and the segment drivers 28 may be realized by general-purpose binary-output STN drivers. A driver IC needs to withstand a voltage of 40 V or more.

The drive control circuit 29 generates signals for controlling the components and supplies the segment drivers 28 with drive image data, in order to update the display of the display element 10 on the basis of image data supplied from outside. The drive control circuit 29 converts a full-color original image (16,770,000 colors; 256 tones for each of R, G, and B) into an image having 4096 colors (16 tones for each of R, G, and B) using a dither process such as error diffusion, in order to generate drive image data to be output to the segment drivers 28. This conversion of tones may be performed using many methods other than the error diffusion, but a systematic dither method and a blue noise mask are preferable in terms of display qualities. The drive control circuit 29 may be realized by a microcomputer, a field-programmable gate array (FPGA), or the like.

When the display is updated, 8 reset pulses having a voltage of ±36 V and a pulse width of 15 ms are applied to all the pixels, thereby performing the reset operation by which the planar state is established.

Next, image data converted into 4096 colors is input to the segment drivers 28 for R, G, and B. For example, in the case of the write operation utilizing accumulated responses, the image data having 4096 colors (16 tones for each of R, G, and B) is divided into pieces of binary image data (H1 to H7) corresponding to middle tones, and the write operation is performed seven times for the entirety of a screen. A voltage of ±24 V is applied to pixels whose tone levels are to be changed, and a voltage of ±10 V, to which the liquid crystal hardly responds, is applied to pixels whose tone levels are to be maintained. By enlarging this approach, display of 260,000 colors is possible.

The configuration of a reflective color display apparatus adopting a cholesteric liquid crystal is widely known and known techniques may be used for items that are not described herein. Therefore, further description of the configuration is omitted.

According to the embodiment, by setting the characteristics of each liquid crystal layer in the above-described manner in a reflective color display panel represented by a cholesteric liquid crystal, the color reproduction range can be maximized and therefore more vivid color display is possible.

Although the embodiment has been described above, various modifications are possible. For example, although a display apparatus that drives the display element according to the embodiment using a conventional driving method has been described in the above example, the display element according to the embodiment may be driven using a dynamic driving method.

In addition, although a cholesteric liquid crystal display element has been described in the embodiment as an example, the characteristics of the reflection spectrum of each layer are effective even if a material other than the cholesteric liquid crystal is used, so long as a display element to be used is a reflective display element.

Furthermore, although a simple matrix type cholesteric liquid crystal display element has been described in the embodiment as an example, the characteristics of the reflection spectrum of each layer are effective even if a display element to be used is a display element that uses other driving methods such as a thin film transistor (TFT) display element, so long as the display element to be used is a reflective display element.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A reflective color display element comprising:
a plurality of pixels arranged in a matrix;
wherein each of the plurality of pixels includes a first hue element, a second hue element, and a third hue element that control a light reflection state and that exhibit three different hues,
wherein reflection spectra of the first hue element, the second hue element, and the third hue element partially overlap,
wherein, with respect to a relationship between main reflection wavelengths of the first hue element, the second hue element, and the third hue element, the main reflection wavelength of the first hue element is the shortest and the main reflection wavelength of the third hue element is the longest, and
wherein, with respect to a relationship among half widths of the first hue element, the second hue element, and the third hue element, the half width of the second hue element is equal to or smaller than the half width of the first hue element, and the half width of the first hue element is smaller than the half width of the third hue element.

2. The reflective color display element according to claim 1,
wherein the main reflection wavelength of the first hue element is shorter than a main wavelength of blue according to a standard RGB, and
wherein the main reflection wavelength of the second hue element is shorter than a main wavelength of green according to the standard RGB.

3. The reflective color display element according to claim 2,
wherein a color exhibited by the first hue element is within a color region of purplish blue or bluish purple, and
wherein a color exhibited by the second hue element is within a color region of green or yellowish green.

4. The reflective color display element according to claim 2,
wherein a color exhibited by the third hue element is within a region ranging from red to orange.

5. The reflective color display element according to claim 1, further comprising:
three panels that are stacked on one another,
wherein a first, a second, and a third of the three panels comprises the first hue element, the second hue element, and the third hue element, respectively.

6. The reflective color display element according to claim 1,
wherein the first hue element, the second hue element, and the third hue element are comprised in a single panel.

7. The reflective color display element according to claim 1, further comprising:
at least two panels that are stacked on each other,
wherein one of the at least two panels comprises at least two of a set including the first hue element, the second hue element, and the third hue element.

8. The reflective color display element according to claim 1,
wherein each of the plurality of pixels comprises a cholesteric liquid crystal.

9. The reflective color display element according to claim 1,
wherein an anisotropy in an index of refraction of a liquid crystal of the first hue element is larger than anisotropies in indices of refraction of liquid crystals of the second hue element and the third hue element.

10. The reflective color display element according to claim 8,
wherein, in a liquid crystal layer that forms each of the plurality of pixels, a cell gap is 3 μm or more and an anisotropy in an index of refraction of a liquid crystal material is within a range from 0.18 to 0.25 ;
wherein anisotropies in indices of refraction of the second hue element and the third hue element are within a range of ±10% of each other; and wherein an anisotropy in an index of refraction of the first hue element is within a range from 110 to 130% of the anisotropies in the indices of refraction of the second hue element and the third hue element.

11. The reflective color display element according to claim 1,
wherein the first hue element has a main reflection wavelength in a range from 430 to 460 nm and a half width in a range from 75 to 115 nm;
wherein the second hue element has a main reflection wavelength in a range from 510 to 540 nm and a half width in a range from 75 to 115 nm; and
wherein the third hue element has a main reflection wavelength in a range from 600 to 630 nm and a half width in a range from 95 to 135 nm.

12. The reflective color display element according to claim 11,
wherein, among the first hue element, the second hue element, and the third hue element, half widths of two hue elements having larger half widths are 1.0 to 1.5 times larger than a half width of a hue element having a smallest half width.

13. The reflective color display element according to claim 12,
wherein, among the first hue element, the second hue element, and the third hue element, peak values of reflectivity of two hue elements having larger peak values of reflectivity are 1.0 to 1.5 times larger than a peak value of reflectivity of a hue element having the smallest peak value of reflectivity.

14. The reflective color display element according to claim 5,
wherein, in the three panels, the panel comprising the first hue element, the panel comprising the second hue element, and the panel comprising the third hue element are stacked in the recited order from a surface to be observed,
wherein a blue cut-off filter is provided between the panel comprising the first hue element and the panel comprising the second hue element, and
wherein a green cut-off filter is provided between the panel comprising the second hue element and the panel comprising the third hue element.

15. A color display apparatus comprising:
a reflective color display element including a plurality of pixels arranged in a matrix,
wherein each of the plurality of pixels includes a first hue element, a second hue element, and a third hue element that control a light reflection state and that exhibit three different hues,
wherein reflection spectra of the first hue element, the second hue element, and the third hue element partially overlap,
wherein, with respect to a relationship between main reflection wavelengths of the first hue element, the second hue element, and the third hue element, the main reflection wavelength of the first hue element is the shortest and the main reflection wavelength of the third hue element is the longest, and
wherein, with respect to a relationship among half widths of the first hue element, the second hue element, and the third hue element, the half width of the second hue element is equal to or smaller than the half width of the first hue element, and the half width of the first hue element is smaller than the half width of the third hue element.
